(19) United States
(12) Patent Application Publication
(10) Pub. No.: US 2005/0216957 A1
(43) Pub. Date: Sep. 29, 2005

(54) Method and apparatus for protecting a remediated computer network from entry of a vulnerable computer system thereinto

(76) Inventors: Carl E. Banzhof, Dallas, TX (US); Richard B. Craighead, Little Elm, TX (US); Kevin Cook, Arlington, TX (US); Jack Hudler, Allen, TX (US)

Correspondence Address: CONLEY ROSE, P.C., 5700 GRANITE PARKWAY, SUITE 330, PLANO, TX, 75024, US

(21) Appl. No.: 10/810,927

(22) Filed: Mar. 25, 2004

(51) Int. Cl. H04L 9/00

(52) U.S. Cl. 726/25; 713/201

(57) ABSTRACT

Method and apparatus for protecting a remediated computer network during reconnection of a previously disconnected computer system. Upon initiation of reconnection to the computer network, the previously disconnected computer system raises a firewall to temporarily limit exchanges between the computer system and the remediated computer network until after a client remediation server residing on the computer network has resolved vulnerabilities of the computer system. The limitations on exchanges between the computer system and the remediated computer network are then removed by lowering the firewall.

### CROSS-REFERENCE TO RELATED APPLICATIONS

Not Applicable.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF THE INVENTION

The invention relates generally to remediated computer networks and, more particularly, to techniques which protect the remediated computer network from adverse effects resulting from the entry of a potentially vulnerable computer system into the remediated computer network.

### BACKGROUND OF THE INVENTION

Each year, computer systems face increasing numbers of vulnerabilities. For example, the Computer Security Institute reported 417 vulnerabilities for the year 1999, 1,090 vulnerabilities for the year 2000, 2,437 for the year 2001, 4,129 for the year 2002 and 3,784 for the year 2003. Not only has the reported number of vulnerabilities increased dramatically since 1999, the increasing number of computer systems which are interconnected with other computer systems in a computer network and the increasing complexity of such networks have made the task of protecting computer systems from such vulnerabilities increasingly difficult. Finally, ever increasing numbers of portable computer systems, for example, laptop, notebook and tablet computers, and docking stations, both of which allow computer users to readily disconnect from and reconnect to a conventionally configured wireline local area network (LAN), as well as the increased availability of wireless LANs, have made the task of protecting computer systems and the computer networks interconnecting such computer systems increasingly burdensome and difficult.

A scenario of particular concern relates to portable computer systems which are periodically used on a computer network. Unlike file servers, personal computers (PCs) and other components of the computer network which are typically fixed at one location, portable computer systems are regularly disconnected from the computer network, used at a remote location and then reconnected to the computer network. Such a scenario exposes both the portable computer system, as well as the other computer systems of the computer network to which the portable computer system is coupled, to a number of potential vulnerabilities. For example, if the computer systems of the computer network are protected by an automated vulnerability resolution system such as the vulnerability resolution system to be hereinbelow described, the portable computer system may inadvertently be disconnected from the computer network prior to or during a scheduled or unscheduled remediation of the portable computer system. As a result, the portable computer system would remain vulnerable to security weaknesses which would otherwise have been addressed during the remediation of the portable computer system. Furthermore, upon a subsequent re-entry of the portable computer system into the computer network, the remainder of the computer network is also placed at risk from the unremediated vulnerability residing on the portable computer system.

Oftentimes, upon disconnection from the network, the portable computer system is temporarily connected to the Internet, for example, using a wireless LAN or other public Internet portal such as those found in airports, hotels and other locations frequented by business travelers. At other times, software may be loaded into the portable computer system while it is disconnected from the computer network. A portable computer system is at risk of acquiring new vulnerabilities at any time during which it is operating outside of a remediated computer network and engaged in the importation of either new applications and/or new data not previously residing on the portable computer system. This danger is of particular concern because, whenever the portable computer system is disconnected from a remediated computer network, the vulnerability resolution system for the remediated computer network is unavailable to resolve any vulnerabilities of the portable computer system until after the portable computer system re-enters the remediated computer network. Furthermore, once the portable computer system has returned to a remediated computer network, it is entirely possible that the newly acquired vulnerability may be transmitted to other computer systems within the remediated computer network before the remediated computer network has an opportunity to resolve the acquired vulnerability.

Currently, many network administrators use vulnerability scanning software or managed security providers to test individual computer systems of a computer network for security weaknesses. Typically, such tools generally provide detailed information on the vulnerabilities found in the computing environment of the tested computer systems, but provide limited means for correcting or resolving the detected vulnerabilities. In order for the network administrator to remove the identified vulnerabilities, the network administrator will typically expend a large amount of labor and resources to identify and/or resolve each identified vulnerability. Additional labor is then required to install the vulnerability remediation on the affected computer systems. Oftentimes, this involves the network administrator visiting each affected computer system and manually applying the necessary remediation thereto. In addition, once a remediation is applied to a computer system, a user can easily remove it or install additional software that invalidates the remediation, thereby wasting all of the effort expended during the initial installation of the vulnerability resolution.

U.S. Patent Publication 2003/0126472 to Banzhof, which is hereby incorporated by reference as if reproduced in its entirety, discloses an automated vulnerability resolution system in which a remediation database is constructed from an aggregation of vulnerability information for plural computer vulnerabilities. A remediation signature to address vulnerabilities of a client computer is constructed and subsequently deployed to the client computer. Banzhof further discloses managed remediation techniques which include the selective deployment of the remediation signatures and resolution of vulnerabilities of client computers. While Banzhof represents a significant improvement over prior techniques which required the manual remediation of vulnerable computer systems, the automated vulnerability resolution system disclosed in Banzhof is configured such that remediations of vulnerable computer systems occur at scheduled times. As a result, if a computer system scheduled for remediation is unavailable at the scheduled time, for example, if the computer system is a portable computer that had been disconnected prior to the scheduled remediation, the scheduled remediation could not be completed. As a result, both the unremediated computer system, as well as any computer systems connected to the unremediated computer system, for example, through a computer network, would remain exposed to adverse effects which could potentially result from the unremediated vulnerability. Further, this exposure would remain until either the occurrence of the next scheduled remediation or until a network administrator notices the failed remediation and initiates an immediate remediation of the unremediated computer system.

It should be readily appreciated, therefore, that a significant advancement in vulnerability resolution systems would be achieved if such systems were configured to protect a remediated computer network from adverse effects which could potentially result from the entry of a vulnerable computer system into the remediated computer network.

### SUMMARY

In one embodiment, the present invention is directed to a method for protecting a computer network from vulnerabilities. In accordance with the claimed method, a computer system seeking to connect to the computer network is quarantined until it is remediated. Once remediation is completed, the quarantined computer system is allowed to connect to the computer network. The process of quarantine and remediation is distributed between the computer system and the computer network. More specifically, the computer system initiates the quarantine while the network provides information necessary for an agent, residing on the computer system to remediate the quarantined computer system. The quarantine of the computer system is accomplished by raising a firewall which blocks traffic between the computer system and the computer network. Preferably, the firewall is configured to permit a flow of vulnerability resolution information therethrough. Once the computer system has been remediated using the vulnerability information, the computer system lowers the firewall.

In another embodiment, the present invention is directed to a method for protecting a computer network comprised of a plurality of computer systems and a client remediation server for resolving vulnerabilities in the plurality of computer systems. In accordance with the claimed method, exchanges between the remediated computer network and a computer system thereof are temporarily limited whenever the computer system is disconnected from the remediated computer network and subsequently reconnected thereto. Preferably, exchanges between the remediated computer network and the computer system are limited until after the client remediation server has checked for pending remediations for the computer system and all such pending remediations have been executed. A firewall may be used to limit exchanges between the computer system and the remediated computer network. The firewall is raised upon reconnection of the computer system to the remediated computer network. Once raised, the firewall filters out non-remediation-related traffic between the computer system and the remediated computer network. The limitations on exchanges between the computer system and the remediated computer network are removed as soon as the client remediation server has provided the information needed for an agent, residing on the computer system, to execute the pending remediations To remove the limitations on exchanges between the computer system and the remediated computer network, the computer system lowers the firewall previously raised, by the computer system, on reconnection of the computer system with the remediated computer network. Once the limitations on exchanges between the computer system and the remediated computer network have been removed, non-remediation-related traffic is able to pass between the computer system and the remediated computer network.

In still another embodiment, the present invention is directed to a remediated computer network comprised of a computer system and a client remediation server, coupled to the computer system, for resolving vulnerabilities in the computer system. In accordance with this embodiment of the invention, the computer system includes a firewall for periodically isolating the computer system from the remediated computer network until: (1) the client remediation server provides a resolution signature that enables an agent, residing on the computer to resolve vulnerabilities of the computer system; and (2) the agent resolves the vulnerabilities of the computer system. In one aspect thereof, the computer system is configured to raise the firewall, thereby isolating the computer system from the remediated computer network, whenever the computer system disconnects from and subsequently reconnects to the computer network. In another aspect thereof, the computer system is configured to raise the firewall upon each power-up thereof and, in still another, the remediated computer network is a LAN and the computer system is configured to raise the firewall upon initiating registration with the LAN.

In yet another embodiment, the present invention is directed to a computer system which includes a processor subsystem, a memory subsystem, at least one application residing in the memory subsystem and executable by the processor subsystem, and a firewall switchable between a closed position in which traffic to and/or from the computer system is restricted and an open position in which traffic to and/or from the computer system is unrestricted. The firewall is configured to switch into the closed position upon power-up of the computer system and upon initiation of registration with a computer network. In one aspect thereof, when in the closed position, the firewall is configured to pass a first type of traffic related to registration of the computer system with a computer network and a second type of traffic related to remediation of the computer system by a client remediation server.

### BRIEF DESCRIPTION OF THE DRAWINGS

FIG. 1 is a block diagram illustrating an automated vulnerability resolution system for remediating one or more computer systems and/or computer networks;

FIG. 2 is an expanded block diagram of a remediated computer system and selected components of a remediated computer network of FIG. 1;

FIGS. 3A-B are a flow chart illustrating a method of remediating one or more computer systems and/or computer networks to protect the computer systems and/or computer networks from vulnerabilities;

FIG. 4 is a flow chart illustrating a method by which a client remediation server remediates a computer network associated therewith;

FIG. 5 is a flow chart illustrating a method of initializing a remediated computer system to enable quarantine of the remediated computer system upon disconnect and subsequent re-entry into a remediated computer network; and

FIG. 6 is a flow chart illustrating a method of quarantining a remediated computer system upon disconnect and subsequent re-entry of the remediated computer system into a remediated computer network.

### DEFINITION OF TERMS

In the detailed description and claims which follow, certain terms are used to refer to particular system components. As one skilled in the art will appreciate, components may be referred to by different names. Accordingly, this document does not intend to distinguish between components that differ in name, but not function.

Also in the detailed description and claims which follow, the terms “including” and “comprising” are used in an open-ended fashion, and thus should be interpreted to mean “including, but not limited to . . . ”.

The term “couple” or “couples” is intended to mean either an indirect or direct electrical, wireline communicative, or wireless communicative connection. Thus, if a first device couples to a second device, that connection may be through a direct connection, or through an indirect connection via other devices and connections.

The terms “remediate” and “remediation” generally refer to addressing or resolving vulnerabilities by reducing or alleviating the security risk presented by the subject vulnerability.

The term “remediated computer network” generally refers to a computer network having one or more computer systems and a client remediation server which has performed at least one resolution of selected vulnerabilities for selected ones of the computer systems.

The term “remediated computer system” generally refers to a computer system for which at least one vulnerability thereof has been resolved by a client remediation server.

### DETAILED DESCRIPTION

The detailed description which follows contains specific details intended to provide the reader with an understanding of how to practice the present invention. However, those skilled in the art will readily appreciate that the present invention may be practiced without such specific details. In other instances, well-known elements have been illustrated in schematic or block diagram form in order not to obscure the present invention in unnecessary detail. Additionally, some details have been omitted inasmuch as such details are not considered necessary to obtain a complete understanding of the present invention, and are considered to be within the understanding of persons of ordinary skill in the relevant art. It is further noted that, unless indicated otherwise, all functions described herein may be performed in either hardware, software, or a combination thereof.

Automated vulnerability resolution systems such as the automated vulnerability system to be more fully described below, have provided numerous benefits to network administrators. More specifically, systems such as these have been able to enhance the protection of computer networks by resolving vulnerabilities within the computer networks before the vulnerabilities have an opportunity to wreak havoc within the computer network, for example, when a fast-spreading computer virus causes any number of computer systems to crash. However, automated vulnerability resolutions systems such as these presume that the various computer systems which make up the computer network are always available for vulnerability resolution at a time chosen by the vulnerability resolution system. Unfortunately, this presumption is often incorrect. For example, by simply powering-down their desktop computer or taking their notebook computer home, a computer user has, in effect, disconnected their computer system from the computer network. Such an act, which many computer users innocently perform at the end of the day, may render the automated vulnerability resolution system charged with the task of protecting the computer network helpless. More specifically, if the, now disconnected, computer system was scheduled to be remediated during the period that it is powered off or physically disconnected from the computer network, any vulnerabilities residing on that computer system will remain unresolved. As a result, the vulnerabilities will remain a threat to the continued health of the entire computer network long after the computer network has supposedly addressed the vulnerability. Thus, in order to ensure that those computer systems which are periodically disconnected from the computer network do not continuously pose a threat to the entire computer network, it has been necessary to modify vulnerability resolution processes such that disconnected computer systems are isolated from the remainder of the computer network until they can be checked for vulnerabilities. Only then can such computer systems be safely returned to the computer network.

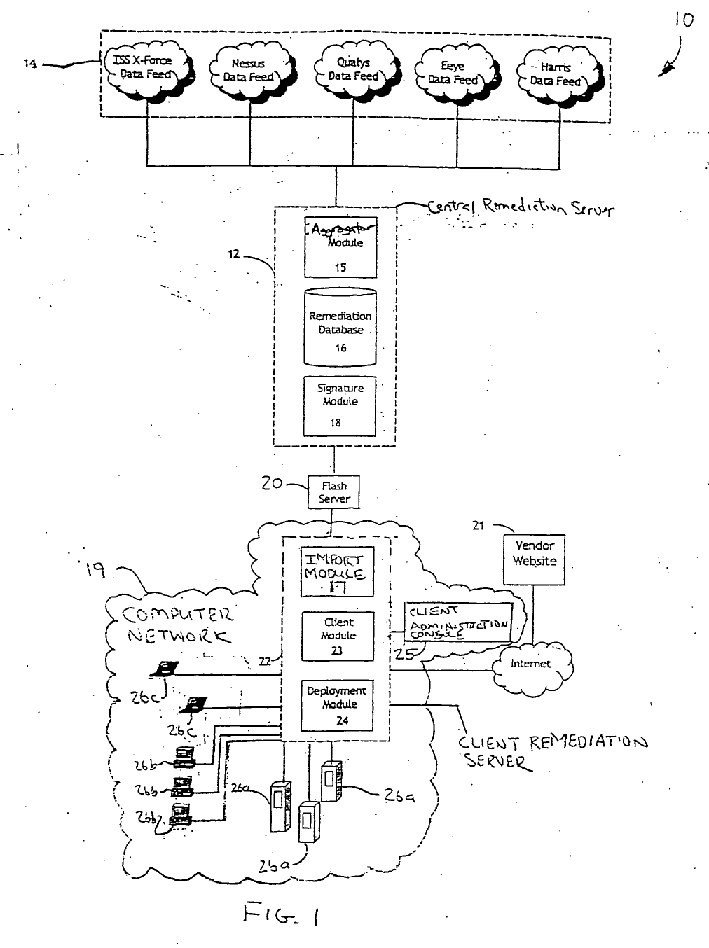

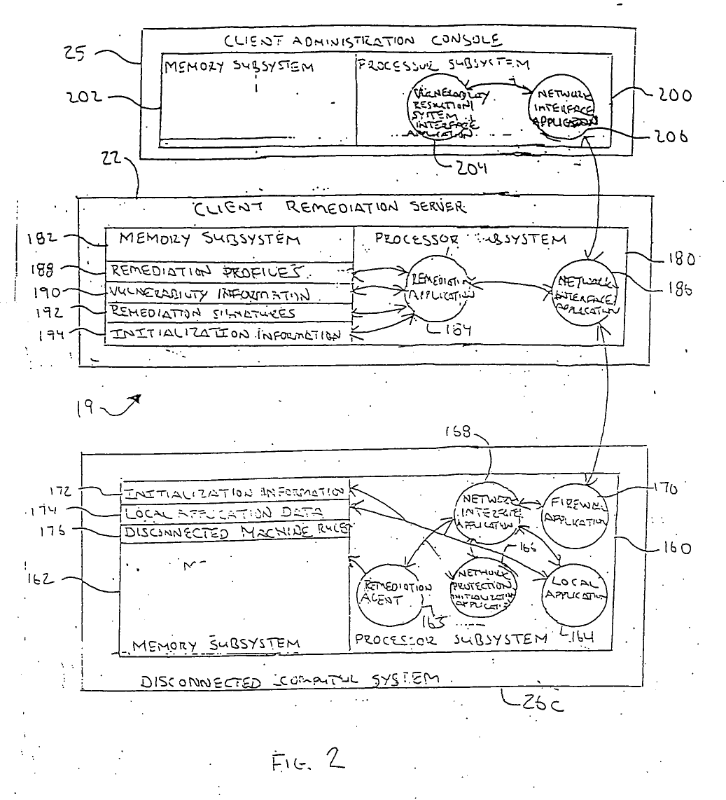

Referring first to FIG. 1, an automated vulnerability resolution system 10 will now be described in greater detail. As may now be seen, the vulnerability resolution system 10 comprises a central remediation server 12 coupled to a plurality of intelligence agents 14, an aggregator module 15, a remediation database 16 and a signature module 18. As used herein, the term “central” is not intended to infer or otherwise suggest any particular physical location of the central remediation server 12. Nor is the term intended to infer or otherwise suggest any particular level of control of the central remediation server 12 over other components of the vulnerability resolution system 10. Rather, as used herein, the term is merely used to distinguish the central remediation server 12, which aggregates vulnerability information and constructs remediation signatures for use by the computer systems and/or networks to resolve vulnerabilities, from client remediation servers, for example, client remediation server 22, which performs remediation on one or more computer systems using remediation signatures downloaded from the central remediation server 12.

In the embodiment illustrated in FIG. 1, the aggregator module 15, the remediation database 16, and the signature module 18 all reside within the central remediation server 12. For example, the aggregator module 15, the remediation database 16 and the signature module 18 may be stored in a memory subsystem (not shown) of the central remediation server 12. It is fully contemplated, however, that one or more of the aggregator module 15, the remediation database 16 and the signature module 18 may reside within one or more discrete devices coupled to the central remediation server 12. It is further contemplated that any such discrete devices within which the aggregator module 15, the remediation database 16 and/or the signature module 18 reside may either be locally or remotely located relative to the central remediation server 12.

As will be more fully described below, the central remediation server 12 provides remediation services to one or more computer networks, for example, computer network 19, coupled to the central remediation server 12 by a web server 20, for example, a VFLASH server. Of course, for ease of illustration, only one such computer network is shown in FIG. 1. If additional computer networks were to receive remediation services form the central remediation server 12, all such additional computer networks would also be coupled to the central remediation server 12 by the VFLASH server 20. Additional VFLASH servers would be necessary only when the demand for remediation services is sufficiently heavy that the additional computer networks can no longer timely download remediation signatures from the VFLASH server 20. Variously, it is contemplated that the computer network 19 may be a LAN, wide area network (WAN), wireless LAN (WLAN), virtual private network (VPN), wireless VPN (WVPN) or the Internet. Of course, the foregoing list is not intended to be exhaustive and it is fully contemplated that other types of computer network would be suitable for the purposes contemplated herein.

The computer network 19 is comprised of the client remediation server 22, import module 17, client module 23, deployment module 24, client administration console 25 and plural computer systems, including, for example, one or more file servers 26a, one or more desktop computers 26b, for example, personal computers (PCs), and/or one or more portable computers 26c, for example, laptop, notebook or tablet computers. In the embodiment illustrated in FIG. 1, the import module 17, the client module 23 and the deployment module 24 reside within the client remediation server 22. For example, the import module 17, the client module 23 and the deployment module 24 may be stored in a memory subsystem (not shown) of the client remediation server 22. It is fully contemplated, however, that one or more of the import module 17, the client module 23 and the deployment module 24 may reside within one or more discrete devices coupled to the client remediation server 22. It is further contemplated that any such discrete devices within which the import module 17, the client module 23 and/or the deployment module 18 reside may either be locally or remotely located relative to the client remediation server 22.

It should be clearly understood that the computer network 19 has been greater simplified for ease of description. For example, in FIG. 1, various types of devices, for example, routers, switches, and printers, which typically form part of a computer network, have been omitted from the drawing. FIG. 1 also shows the computer network 19 as including only a single client remediation server, specifically, the client remediation server 22. It should be clearly understood that, depending on the configuration of the computer network 19, additional client remediation servers may be required. Of course, when plural client remediation servers are required, each such client remediation server should be coupled to the client administration console 25 in a manner similar to that illustrated with respect to the client remediation server 22. Also, FIG. 1 shows each one of the file servers 26a, PCs 26b and portable computers 26c as being directly coupled to the client remediation server 22. However, depending on the particular configuration of the computer network 19, one or more of these devices may instead be indirectly coupled to the client remediation server 22, typically, through another network device. For example, a PC may be coupled to the client remediation server 22 through a file server. Finally, the interconnections between the various ones of the network devices such as the file servers 26a, the PCs 26b and the portable computers 26c of the computer network 19 have been omitted from FIG. 1 for ease of description.

To resolve vulnerabilities in computer systems, for example, the file servers, PCs and portable computers 26a, 26b and 26c of the computer network 19, the central remediation server 12 must obtain information relating to computer security vulnerabilities from the intelligence agents 14. The aggregator module 15 provides the necessary interface between the central remediation server 12 and the various intelligence agents which maintain information relating to computer security vulnerabilities. Examples of intelligence agents include: ISS Internet Scanner, QualysGuard, Nessus, Eeye, Harris, Retina, Microsoft's hfNetCheck, and others. The vulnerability information from the intelligence agents 14 may come in many forms. Two such forms include 1) general information from security intelligence organizations relating to known security vulnerabilities, such as vulnerabilities in widespread software applications like Microsoft Windows; and 2) specific information from scanning services.

From whatever source received, the central remediation server 12 aggregates the obtained vulnerability information in the remediation database 16. While aggregating the vulnerability information into the remediation database 16, the central remediation server 12 may manipulate the information in various manners. For example, the central remediation server 12 may strip unnecessary portions of the acquired vulnerability information, sort the vulnerability information into related vulnerabilities, remove or duplicate selected vulnerability information and/or identify or otherwise establish associations between related vulnerabilities. Of course, the foregoing should not be considered to be an exhaustive list of the types of manipulation of vulnerability information which may be performed by the central remediation server 12 while aggregating acquired vulnerability information into the remediation database 16.

In addition, the central remediation server 12 uses the signature module 18 to generate remediation signatures for each one of the acquired vulnerabilities. Typically, a remediation signature is a list of actions which must be taken to address or otherwise resolve one or more vulnerabilities. As disclosed herein, the remediation signatures include the following types of remediation actions: service management, registry management, security permissions management, account management, policy management, audit management, file management, process management, as well as service pack, hot fix and patch installation. Each one of the foregoing types of remediation actions are generally known in the computer security industry and need not be herein described in further detail. Of course, it should be noted that the foregoing types are provided by way of example and it is fully contemplated that a remediation signature may encompass a wide variety of other types of remediation actions in addition to those specifically recited herein.

As previously set forth, a remediation signature may address one or more vulnerabilities. For clarity of description, however, it will hereafter be presumed that each remediation signature addresses a single vulnerability. Preferably, each remediation signature is constructed by the central remediation server 12 in the form of an abstract object which can be developed and implemented across multiple platforms without the need to change the underlying source code used by the central remediation server 12 to construct the signature. As a result, remediation signatures may be constructed by the central remediation server 12 and subsequently used in whatever system or environment that the client remediation server 22 is operating. The process of constructing a remediation signature may be an entirely automated process, a partially automated process having a limited degree of manual intervention required, a partially automated process requiring extensive manual intervention or an entirely manual process.

For example, in addition to the provided vulnerability information, some intelligence agents 14 may also provide or suggest remediations for those vulnerabilities. In such situations, the process of constructing a remediation signature may be streamlined significantly, thereby reducing the needed level of manual intervention. Further, depending on the level of complexity of the vulnerability, a corresponding level of complexity may be required for the remediation signature. For example, some vendors provide “patches”, “fixes” or “updates” that address vulnerabilities in their hardware or software via their vendor website. A remediation signature may, therefore, include a link to a vendor website where a patch or update is available for download. Similarly, an action to be undertaken as part of a remediation of a vulnerability of a computer system may include the download of the patch or update identified in a remediation signature. It should be appreciated that, given the potential complexity of a remediation signature, remediation signatures may not always execute successfully upon completing the initial construction thereof. Accordingly, either the central remediation server 12 or a component thereof, for example, the signature module 18, should be further configured with the ability to test and approve a newly constructed remediation signature, thereby ensuring that the newly constructed remediation signatures successfully resolve the intended vulnerability and do not have any unintended deleterious effects.

Once a remediation signature has been constructed by the central remediation server 12, the remediation signature is assigned or otherwise associated with the corresponding vulnerability in the remediation database 16. Accordingly, the remediation database 16 may include vulnerability information and the corresponding remediation signatures for those vulnerabilities. Alternatively, it is contemplated that the remediation signatures could be stored elsewhere and remotely associated to the corresponding vulnerabilities using a pointer or other suitable association technique.

The central remediation server 12 periodically posts remediation signatures and the associated vulnerability information to the VFLASH server 20 for dissemination to client computer networks such as the computer network 19 which receive remediation services from the central remediation server 12. Typically, a remediation signature will not be posted to the VFLASH server 20 until after it has been tested and approved, by the central remediation server 12, for dissemination to clients seeking resolution of vulnerabilities in their computer systems or computer networks. Once uploaded to the VFLASH server 20 by the central remediation server 12, a client remediation server such as the client remediation server 22 can download the posted remediation signatures from the VFLASH server 20. In this embodiment, a download is typically initiated by a user, such as an IT or computer security personnel, operating the client administration console 25. Alternately, the user may schedule a download of the remediation signatures to occur at a selected time or schedule recurring downloads at selected times or intervals.

The client remediation server 22 may connect to the VFLASH server 20 in any number of ways such as establishing an Internet connection or establishing a direct dial-up connection. As disclosed herein, the client module 23 provides the necessary interface logic to download the information from the VFLASH server 20. Typically, the client remediation server 22 will periodically download information from the VFLASH server 20 as part of a check for updated vulnerability and remediation information. The client remediation server 22 may also access vendor websites 21, via a global network such as the Internet or otherwise, to obtain additional patches or updates as needed for remediation. As disclosed herein, the client remediation server 22 analyzes and interprets the signatures downloaded from the VFLASH server 20. If a signature specifies a needed update or patch from a vendor website 21, the client remediation server 22 will connect to the website and download the needed information making the patch or update available locally for remediation of appropriate ones of the client computers 26a, 26b and 26c coupled to the client remediation server 22.

It is further contemplated that the client remediation server 22 will maintain a profile of the computer systems 26a, 26b and 26c which rely on the client remediation server 22 for vulnerability resolution. Generally speaking, each of these profiles consists of a record or log of system information related to a respective one of the computer systems 26a, 26b and 26c. More specifically, the profile for any given one of the computer systems 26a, 26b and 26c will contain information related to remediations performed on that computer system 26a, 26b or 26c. It is contemplated, however, that the profile may also contain additional information related to the computer system 26a, 26b or 26c which would be helpful in managing security issues for that computer system. For example, the profile may contain information on the software applications and versions currently installed in the computer system 26a, 26b or 26c. By comparing profiles for the computer system 26a, 26b or 26c with the remediation signatures downloaded from the VFLASH server 20 and the vulnerability information acquired by the client remediation server 22, for example, by scans of the computer systems 26a, 26b and 26c by a vulnerability assessment tool, it is contemplated that the client remediation server 22 will be able to determine which remediation or remediations are required for each computer system 26a, 26b, 26c of the computer network 19 to resolve identified vulnerabilities associated therewith. It is further contemplated that, by using the profiles, the client remediation server 22 can manage the vulnerability resolution process for each computer system 26a, 26b, 26c of the computer network 19. For example, the client remediation server 22 itself, or security or IT personnel accessing the client remediation server 22 via the client administration console 25, could select which remediation signatures downloaded from the VFLASH server 20 should be deployed to each computer system 26a, 26b, 26c, or which vulnerabilities should or should not be addressed for each computer system 26a, 26b or 26c. In addition, vulnerability resolution can be managed by scheduling the various resolution events. For instance, when and how often the computer systems 26a, 26b, 26c are scanned for vulnerabilities can be scheduled, as well as the timing for deployment of the remediation signatures to address those vulnerabilities.

By managing the vulnerability resolution, the remediation of vulnerabilities can be addressed with both greater reliability and cost effectiveness. In particular, it is contemplated that the remediation can be scheduled to occur in off hours to minimize impact on the productivity of the computer systems 26a, 26b, 26c. The remediation can also be selectively implemented. The remediation can be tracked and logged so that remediations are not accidentally overwritten or undone. Finally, the client remediation server 22 may execute the remediation automatically, thereby eliminating any need to manually perform and/or install the remediation manually on each computer system, a virtually impossible task for some large-scale companies.

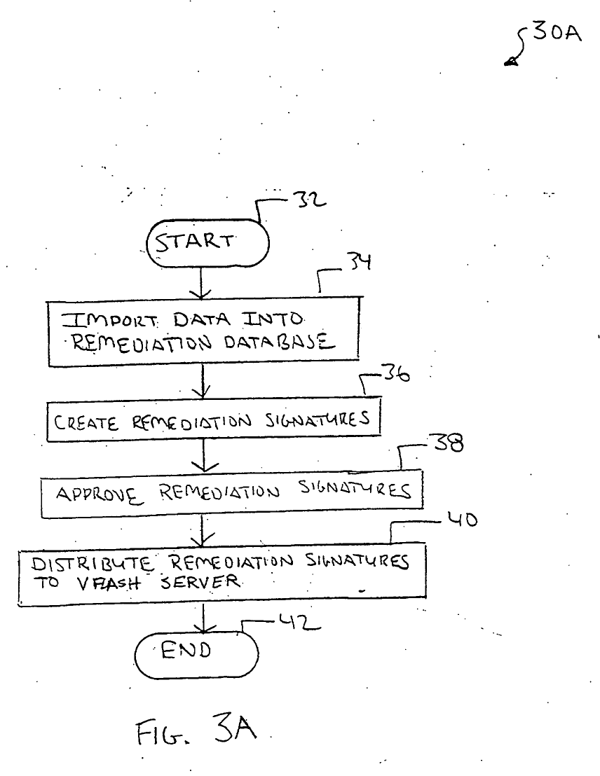

Referring next to FIG. 2, the structure of the disconnected computer system 26c and first and second components of the remediated computer network 19, specifically, the client remediation server 22 and the client administration console 25 will now be described in greater detail. The disconnected computer system 26c includes a processor subsystem 160, for example, a central processing unit (CPU) coupled to a memory subsystem 162 by a system bus (not shown). As disclosed herein, the processor subsystem 160 represents the collective processing functionality of the disconnected computer system 26c and may be distributed amongst any number of processing devices. Similarly, the memory subsystem 162 represents the collective storage functionality of the disconnected computer system 26c and, like the processor subsystem 160, may be distributed amongst any number of memory devices.

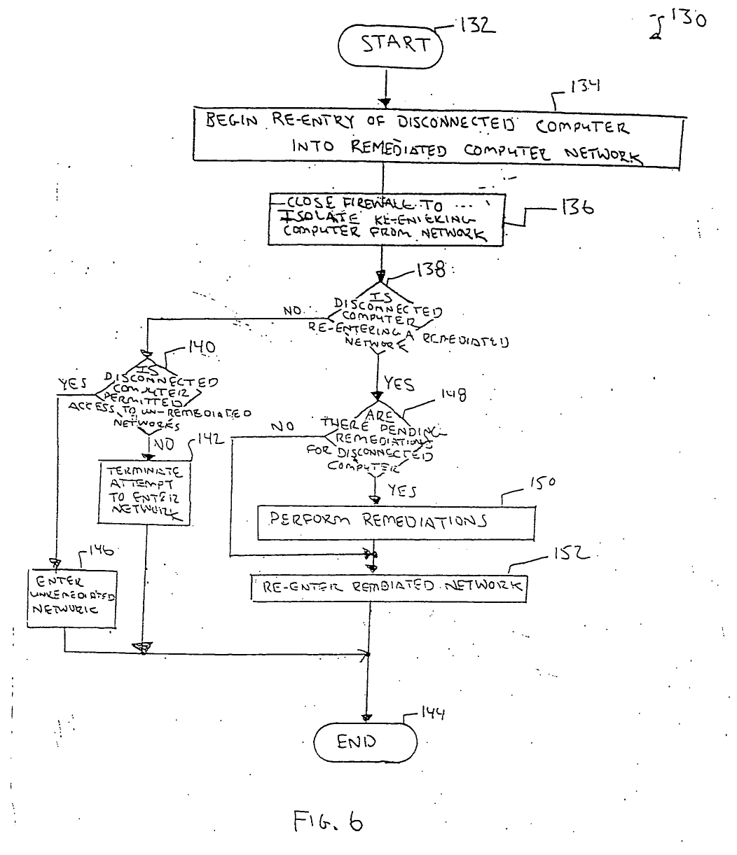

Residing on the processor subsystem 160 are a remediation agent 163, a first (or local) application 164, a second (or network protection initialization) application 166, a third (or network interface) application 168 and a fourth (or firewall) application 170. The remediation agent 163 and each of the applications 164 through 170 are respectively comprised of a series of encoded instructions which reside in the memory subsystem 162 and are executable by the processor subsystem 160. Also residing in the memory subsystem 162 are plural types of information. Each type of information may be stored at plural locations within the memory subsystem 162 which are associated with one another or, as illustrated in FIG. 6, the memory subsystem 162 may be subdivided into plural memory areas, each of which maintains a specified type of information. For example, the memory subsystem 162 includes a first memory area 172 in which initialization information is maintained, a second memory area 174 in which local application data is maintained and a third memory area 176 in which a set of disconnected machine rules is maintained.

While a vulnerability may occur anywhere within the disconnected computer system 26c, most often, they appear within the local application 164 or within the local application data area 174 which contains the data on which the local application 164 operates. Of course, while only a single local application is shown in FIG. 2, typically, the disconnected computer system 26c would include plural local applications and plural local application data areas, each susceptible to vulnerabilities. As will be more fully described below, such vulnerabilities are remediated by the remediation agent 163 using a remediation signature downloaded to the disconnected computer system by the client remediation server 22.

While the network interface application 168 provides the interface between the various applications, specifically, the local application 164, the remediation agent 165 and the network protection initialization application 166, of the disconnected computer system 26c to the remediated computer network 19, it is the implementation of a firewall that enables the disconnected computer system 26c to periodically quarantine itself from the remediated computer network 19, for example, when the disconnected computer system 26c seeks to re-connect with the remediated computer network 19. While firewalls may be implemented in either hardware or software, FIG. 1 shows a software-implemented firewall, specifically, the firewall application 170. The firewall application 170 works by limiting the flow of traffic between the network interface application 168 and the network interface applications of the various devices which collectively form the remediated computer network 19, for example, a network interface application 186 of client remediation server 22. The firewall application 170 is switchable between first and second states. In the first state, the firewall would be considered as being in a closed position in which traffic to and/or from the disconnected computer system 26c is limited while, in the second state, the firewall would be considered as being in an open condition in which traffic to and/or from the disconnected computer system 26c is unrestricted. Finally, when in the closed position, traffic between the disconnected computer system 26c and the client remediation server 22 is typically limited to (1) signals identifying the client remediation server 22 and/or the disconnected computer system 26c; and (2) signals containing remediation signatures.

The client remediation server 22 includes a processor subsystem 180, for example, a CPU, coupled to a memory subsystem 182 by a system bus (not shown). As disclosed herein, the processor subsystem 180 represents the collective processing functionality of the disconnected computer system 22c and may be distributed amongst any number of processing devices. Similarly, the memory subsystem 182 represents the collective storage functionality of the disconnected computer system 22 and, like the processor subsystem 180, may be distributed amongst any number of memory devices. Residing on the processor subsystem 180 are a first (or remediation) application 184 and a second (or network interface) application 186. The first and second applications 184 and 186 are each comprised of a series of encoded instructions which reside in the memory subsystem 182 and are executable by the processor subsystem 180. As will be more fully described below, the remediation application 184 provides remediation signatures to the remediation agent 163 for use in resolving vulnerabilities for the disconnected computer system 26c. Also residing in the memory subsystem 182 are plural types of information. Each type of information may be stored at plural locations within the memory subsystem 182 which are associated with one another or the memory subsystem 182 may be subdivided into plural memory areas, each of which maintains a specified type of information. For example, the memory subsystem 182 includes a first memory area 188 in which remediation profiles are maintained, a second memory area 190 in which vulnerability information is maintained, a third memory area 192 in which remediation signatures are maintained and a fourth memory area 194 in which initialization information is maintained.

The client administration console 25 includes a processor subsystem 200, for example, a CPU, coupled to a memory subsystem 202 by a system bus (not shown). As disclosed herein, the processor subsystem 200 represents the collective processing functionality of the client administration console 25 and may be distributed amongst any number of processing devices. Similarly, the memory subsystem 202 represents the collective storage functionality of the client administration console 25 and, like the processor subsystem 200, may be distributed amongst any number of memory devices. Residing on the processor subsystem 200 are a first (or vulnerability resolution system interface) application 204 and a second (or network interface) application 206. The applications 204 and 206 are each comprised of a series of encoded instructions which reside in the memory subsystem 202 and are executable by the processor subsystem 200.

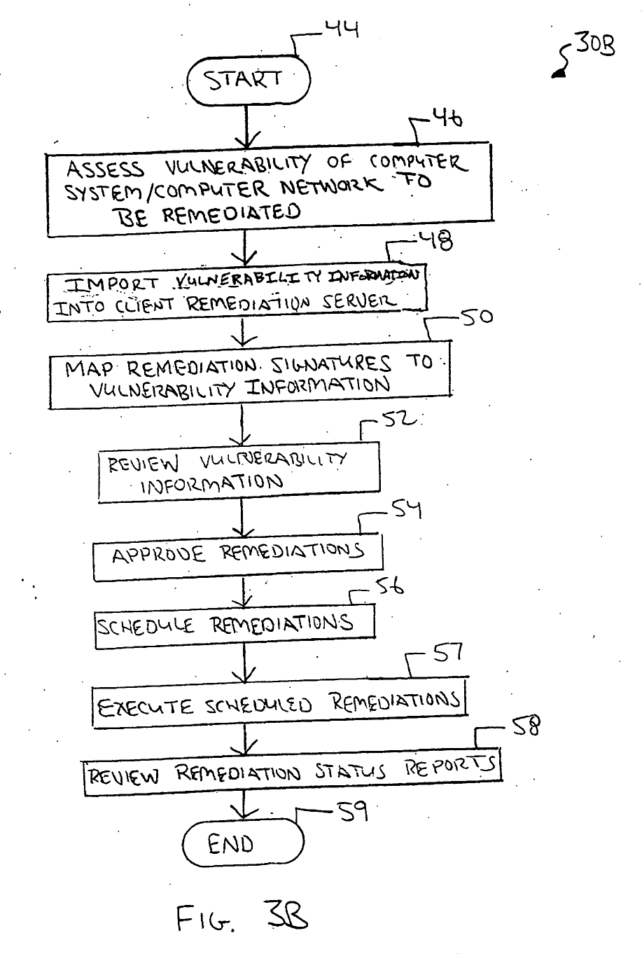

Referring next to FIGS. 3A-B, a method of remediating vulnerabilities in one or more computer systems and/or computer networks will now be described in greater detail. The remediation process illustrated in FIGS. 3A-B is comprised of two portions, a first portion 30A (FIG. 3A) executed at the central remediation server 12 and a second portion 30B (FIG. 3B) executed at the client remediation server 22. Of course, it should be clearly understood that the disclosed association of particular functionality with a specific one of either the central remediation server 12 or the client remediation server 22 is purely exemplary and it is fully contemplated that selected functionality may migrate downwardly from the central remediation server 12 to the client remediation server 22 or migrate upwardly from the client remediation server 22 to the central remediation server 12.

The first portion 30A of the remediation process commences at step 32 and, at step 34, the aggregator module 15 imports or otherwise aggregates information relating to computer security vulnerabilities, acquired from the intelligence agents 14, within the central remediation server 12, typically, within the remediation database 16. Continuing on to step 36, the signature module 18 of the central remediation server 12 may construct one or more new remediation signatures to address the vulnerabilities aggregated within the remediation database 16 and, at step 38, the constructed remediation signatures are approved for deployment to the VFLASH server 20. Of course, the remediation signatures, which, as previously noted, were constructed to remediate identified vulnerabilities, may be tested and revised before being approved for deployment. Upon approval of the remediation signatures, the method proceeds to step 40 for distribution of the remediation signatures to the client remediation server 22, for example, via the VFLASH server 20. Upon distributing the remediation signatures at step 40, the first portion 30a of the remediation process ends at step 42.

Referring next to FIG. 3b, the second portion 30b of the remediation process will now be described in greater detail. The second portion 30b of the remediation process, which, as previously set forth, is executed at the client remediation server, commences at step 44. At step 46, the vulnerability of the computer network 19 is assessed. As disclosed herein, vulnerability assessment encompasses a wide variety of processes and techniques employed using any number of tools including the use of automated assessment tools (not shown) to perform audit processes and the use of intelligence agents (not shown), residing within the computer network 19, to verify the existence of known vulnerabilities on each computer system 26a, 26b and 26c of the computer network 19 to receive remediation services from the client remediation server 22. Vulnerability assessment may also include device discovery; e.g., the mapping of network and subnetwork components to be assessed and identifying the devices that will be targeted for vulnerability assessment. Typically, vulnerability assessment is performed using one or more assessment tools and may include one or more of the aforementioned ISS Internet Scanner, QualysGuard, Nessus, Eeye, Harris, Retina, Microsoft's hfNetCheck intelligence agents.

At step 48, the vulnerability information acquired by the intelligence agents of the computer network 19 is imported into the client remediation server 22 by the import module 17 for aggregation within memory subsystem 182 of the client remediation server 22. Proceeding on to step 50, each of the vulnerabilities imported into the client remediation server are associated with corresponding remediation signatures downloaded from the central remediation server 12 by a mapping process. Continuing on to step 52, the aggregated vulnerability information and associated remediation signatures are then reviewed. Typically, the review process includes analyzing the vulnerability information to prioritize and identify vulnerabilities for remediation, as well as acceptable risks (i.e., where no remediation is required) and, at step 54, approved for dissemination to targeted computer systems execution by the network administrator. At step 56, the time, place and manner of the remediation is scheduled. By scheduling the remediation, it is possible for an administrator to ensure that the remediation occurs during off-peak times in which interference with normal computer operations would be minimized, is limited to a targeted group of computer systems identified as in need of remediation, or occurs in a desired manner.

Proceeding on to step 57, the scheduled remediations of the computer systems 26a, 26b and 26c of the computer network 19 are performed. To perform the remediations, the client remediation server 22 delivers the appropriate remediation signature to a computer system, for example, the computer system 26c. There, the remediation signature is executed by the remediation agent 165, thereby resolving the vulnerabilities of he computer system 26c. Upon completion of the scheduled remediation at step 57, the method proceeds to step 58 for review of the completed remediation. For example, status reports or other reporting tools may be used by the client remediation server 22 to determine if the scheduled remediation was successfully completed. In addition, remediation events may be logged or otherwise recorded to preserve information related to the completed remediation. Such information may be included in profiles for the computer systems 26a, 26b, 26c residing at the client remediation server 22. As previously noted, such profiles may include information about the remediated computer systems such as system configuration, software, and prior remediation actions or a remediation history. Having such information allows for managed remediation of the computer systems 26a, 26b, and 26c. After reviewing the completed remediation at step 58, the method ends at step 59.

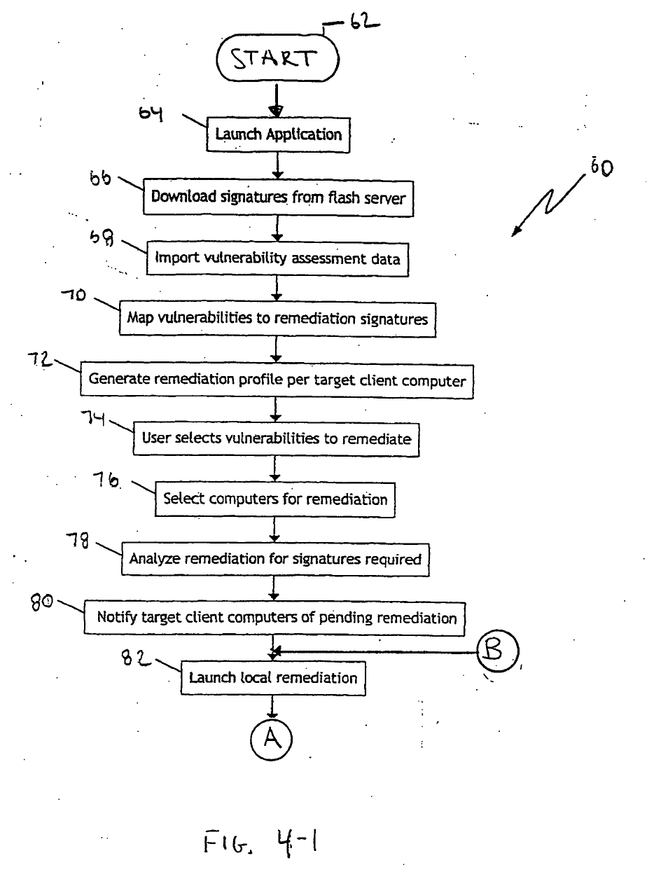

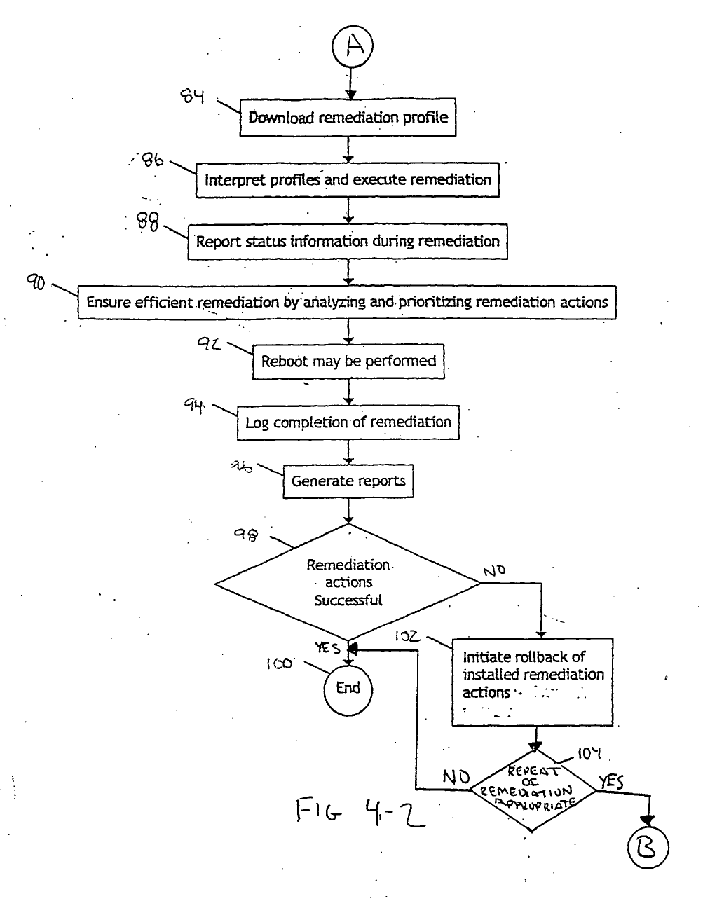

The remediation process described with respect to FIGS. 3A-B represents an overall description of a remediation process which includes vulnerability assessment, vulnerability remediation, and vulnerability management components. These components of the remediation process will now be described in greater detail with respect to FIG. 4.

FIG. 4 is a flow chart illustrating an embodiment of a remediation management process 60 for computer vulnerability remediation in accordance with the present invention. The remediation management process 60 is typically a software application, for example, the remediation application 184, installed on a client remediation server, for example, the client remediation server 22, which is coupled to a plurality of target client computers, for example, the portable computers 26c, which may require remediation of security vulnerabilities. Accordingly, the process 60 begins at step 64 by launching the remediation application 184. Proceeding on to step 66, available remediation signatures and vulnerability information are downloaded, typically from a VFLASH server, for example, the VFLASH server 20. At step 68, vulnerability assessment data is imported. Typically, this vulnerability assessment data comes from scanning tools which have scanned or analyzed the target computers for which remediation is being considered. The vulnerability assessment data includes information regarding the security vulnerabilities found on the target computers or devices. Based on the vulnerabilities identified on the target computers, the vulnerabilities are then mapped to remediation signatures at step 70. In this embodiment, mapping of the identified vulnerabilities to corresponding remediation signatures occurs by referencing the remediation database information downloaded from the VFLASH server 20. It is contemplated, however, that this information may have been previously downloaded, remotely accessed, or presently downloaded to make the necessary correlation between vulnerabilities and available signatures.

Continuing on to step 72, a remediation profile is then generated for each target, for example, the portable computer 26c, and stored in the remediation profile area 188. As noted, each remediation profile typically includes information regarding the vulnerabilities identified on the target client computer as well as the corresponding signatures to address those vulnerabilities. At step 74, the client administrator, typically an IT person or other computer security personnel, is given the opportunity to select which vulnerabilities should be remediated. Generally, the selection is made by reviewing the information regarding vulnerabilities, proposed signatures, and profiles maintained in the remediation profile area 72. The selection and review may be made for each computer or by vulnerability. For example, a particular computer could be selected not to receive any remediation, perhaps because the computer does not pose a significant security risk, the vulnerabilities on the computer are not significant, the processes running on the computer cannot be interrupted for remediation, etc. Alternatively, a particular vulnerability could be deselected for all target client computers, such that the vulnerability would not be remediated on any of the target computers, perhaps because the vulnerability does not pose a sufficient security risk, the remediation signature is deemed too risky, etc. The review process could also include a compliance check in which target computers are checked for compliance with the proposed remediation. For example, while the remediation signature for a target computer may include the installation of a patch, a compliance check may reveal that the patch is already installed on the target computer.

Once the user has selectively managed which vulnerabilities will be remediated by the remediation application 184, at step 76, the user can then select which computers will be approved to receive remediation. At step 78, the proposed remediation is analyzed to determine which remediation signatures will be required and, at step 80, the target client computers that are to receive remediation are notified that a remediation is to occur. In the embodiment disclosed herein, the notification essentially comprises a message passed to a local remediation application (not shown) installed on each target computer. Included in the remediation notification may be when the remediation is scheduled to occur. For instance, the remediation can be scheduled to occur at the instance of a particular event, such as a user logging off the machine, logging in, or any other action. In addition, the remediation may be scheduled to occur at a particular time. If desired, the remediation may be scheduled to occur at multiple times, thereby insuring that an important remediation is not inadvertently or maliciously removed during a subsequent usage of the target computer. In either event, using the target client computer's local clock, the remediation can be initiated at the scheduled time. Or alternatively, the remediation could occur as soon as the notification is received at the target client computer. Regardless of the triggering event, when the trigger is met the local remediation is launched at step 82.

Once the remediation is launched at step 82, the process 60 continues on to step 84 where the remediation profile for the client computer is downloaded. Typically, the profile is downloaded from the client server on which the client remediation management process application, typically, the remediation application 188, is running, i.e., the server that initially sent the notification of the pending remediation. The profile is then interpreted and the remediation signatures and actions specified in the profile are executed at step 86. The execution process could also include a compliance check for each signature to be executed, or even for each action in each signature, in which the client computer is checked for compliance with the proposed remediation before actual execution of the remediation signature or action. For example, while the remediation signature for the client computer may include the installation of a patch, a compliance check may reveal that the patch is already installed on the client computer. This could also provide some additional benefit in that if, as discussed above, certain key remediations are rerun regularly to insure that they have not been undone by later activity on the client computer, then the compliance check reduces the overhead addition of this activity since the remediation can stop at the compliance check if the previous work has not been undone. Continuing on to step 88, during remediation of the computer system 26c, the status of the remediation may be reported to the client remediation server 22 and monitored at the client administration console 25. In addition, the remediation steps may be prioritized and analyzed at step 90 to ensure the most efficient sequence of execution. At step 92, a reboot may be performed if needed for some of the remediation actions to take effect. Completion of the remediation on the computer system 26c or other target client computer is then logged to the client remediation server at step 94. Once remediation is completed, the method proceeds to step 96 for generation of one or more reports indicative of the effect of the remediation. Whether the remediation was successful or not is determined, at step 98, based upon the reporting generated at step 96. If the remediation is not deemed successful, either because it did not resolve the identified vulnerabilities as evidenced by an additional security scan of the client computer, or because the remediation actions had unintended deleterious effects, etc., the process 60 will proceed on to steps 102 and 104 where the remediation can be rolled back or undone and repeated. The process would then return to an appropriate step, for example, step 82, the point at which the local remediation was launched.

Returning to step 98, if the remediation is deemed successful, for example, vulnerabilities are resolved and no deleterious effects are noticed, then the process 60 ends at step 100. In this manner, the new and updated remediation signatures made available to address or resolve identified vulnerabilities can be downloaded and used in an automated and managed remediation deployment to target client computers.

Having described the process of remediating a computer system, typically a computer system which is but one component of a larger remediated computer network, the process by which a remediated computer network, such as the computer network 19, is protected from adverse effects which may result when a remediated computer system, such as the portable computer 26c, disconnects from the computer network 19 and subsequently initiates a re-entry into the computer network 19 will now be described in greater detail. Unlike other processes used to protect computer networks, in accordance with the present invention, the protection process is implemented at the computer system level, e.g., by each remediated computer system of the remediated computer network. Accordingly, in order for a remediated computer system to protect the remediated computer network, each remediated computer system must be initialized so that the protection process may be properly executed upon re-entry into the remediated computer network. The remediated computer system is initialized by executing a network protection initialization process 110. It is contemplated that the initialization process 110 may be executed at any time. For example, the remediated computer system may be configured to execute the initialization process 110 whenever disconnection of the remediated computer system from the remediated computer network is initiated. Of course, the initialization process may instead be executed at other times. For example, the network protection initialization process 110 may be executed during the assessment of the remediated computer system at step 34 (see FIG. 2). Of course, if initialized at these alternate times, there remains some possibility that the network protection process may be de-initialized before the next disconnection of the remediated computer system.

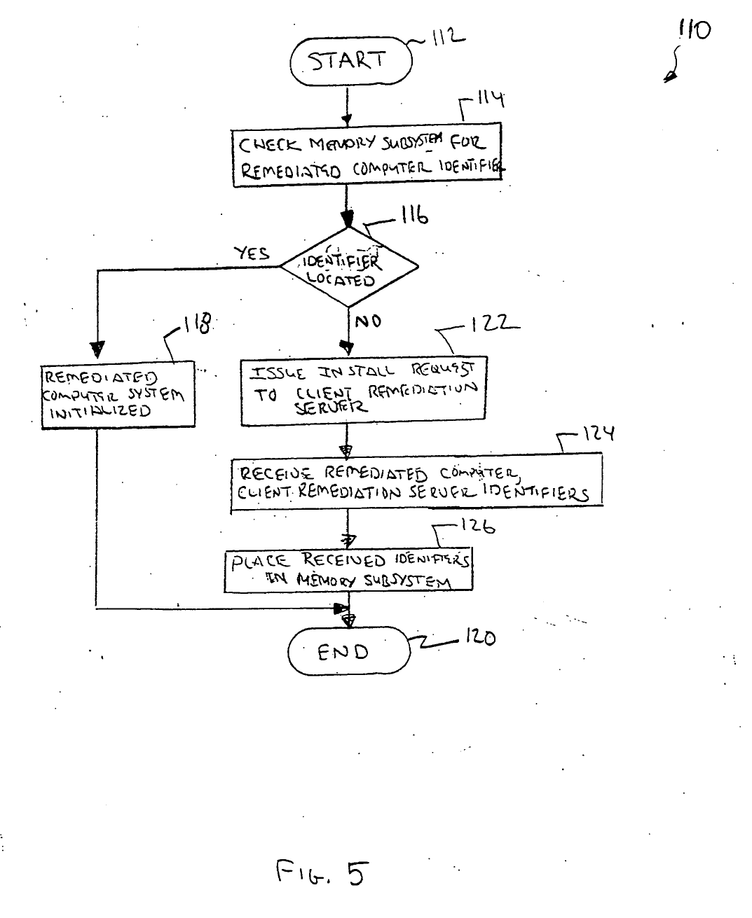

Referring now to FIG. 5, the network protection initialization process 110 will now be described in greater detail. The process 110 commences at step 112 and, at step 114, the remediated computer 26c checks memory subsystem 162 for a remediated computer system identifier, a unique identifier generated by the client remediation server 22 upon successfully initializing the remediated computer system 26c. Continuing on to step 116, if the remediated computer system 26c locates a remediated computer system identifier, the process 110 continues on to step 118 where the remediated computer system 26c determines that it has already been initialized. The process 110 will then continue on to step 120 where the network protection initialization process 110 ends.

Returning now to step 116, if the remediated computer system 26c fails to locate a remediated computer system identifier in the memory subsystem 162, the remediated computer system 26c concludes that the network protection process has not yet been initialized and the process 110 proceeds to step 122 where the remediated computer system 26c begins the initialization process by issuing an installation request to the client remediation server 22. Continuing on to step 124, the client remediation server 22 replies by returning the remediated computer system identifier, together with a client remediation server identifier which uniquely identifies the client remediation server 22. At step 126, the remediated computer system 26c stores both the remediated computer system identifier and the client remediation server identifier in the memory subsystem 162. The process 110 then returns to step 120 where, as previously set forth, the network protection initialization process 110 ends.

Having completed the network protection initialization process 110, the disconnection of the remediated computer system 26c from the remediated computer network 19 may proceed. It is contemplated that disconnection of the remediated computer system 26c may occur in various ways and encompass various potential usages of the remediated computer system 26c. The most common such disconnection would occur when the remediated computer system 26c remains physically coupled to the remediated computer network 19 but the remediated computer system 26c has been powered-down. It is contemplated that this type of disconnection would likely occur with the greatest frequency because computer systems that are not readily portable, for example, the file servers 26a and the PCs 26b, may also be powered down with ease.

While the remediated computer system 26c remains in a powered down condition, the central remediation server 22 is unable to communicate with the remediated computer system 26c. As a result, if a next remediation of the remediated computer system 26c is scheduled to take place while the remediated computer system 26c remains in a powered down condition, the scheduled remediation will not occur. Absent the network protection method to be more fully described below, this places the entire remediated network 19 at risk. For example, during the period of time separating successive remediations of the remediated computer system 26c, a vulnerability to an application residing on the remediated computer system may have been identified and a corresponding remediation signature constructed by the central remediation server 12 and subsequently downloaded to the client remediation server 22. Because the remediated computer system 26c is disconnected when the next scheduled remediation is to occur, the vulnerability in the remediated computer system 26c will remain unresolved. As a result, absent the network protection process disclosed herein, the vulnerability would place both the remediated computer system 26c and the entire remediated computer network 19 at risk to the particular adverse effects associated with that particular vulnerability. Of course, while the review of status reports at step 50 (FIG. 2) will identify an unsuccessful attempt to remediate the disconnected computer system 26c, it is noted that such reviews only occur periodically. As a result, the remediated computer network 19 will remain exposed to the vulnerability while awaiting identification of the failed remediation and initiation of appropriate corrective action. Similarly, while the next scheduled remediation of the remediated computer system 26c after re-entry of the remediated computer system 26c into the remediated computer system would also resolve the vulnerability residing on the remediated computer system 26c, the remediated computer network 19 will remain exposed to the vulnerability while awaiting the next regularly scheduled remediation of the remediated computer system 26c after re-entry of the remediated computer system 26c into the remediated computer network 19.

In addition to the aforementioned powering down of the remediated computer system 26c while leaving the remediated computer system physically connected to the remediated computer network 19, disconnection of the remediated computer system 26c may occur as part of several other processes. For example, a user may wish to transport the remediated computer system 26c to a second location where usage of the remediated computer system 26c is resumed. For example, the remediated computer system 26c may be a portable computer physically connected to the remediated computer network 19 by a docking station. Portable computers such as these are frequently powered down, physically disconnected from both the docking station and the remediated computer network 19 and physically transported to the second location. As before, while the remediated computer system 26c is disconnected from the remediated computer network 19, vulnerabilities residing on the remediated computer system 26c cannot be resolved by client remediation server 22. Physical disconnection and transport of the remediated computer system 26c will expose the entire remediated computer network 19 in the manner previously set forth. Additionally, when physically transported to remote locations, the risk of the remediated computer system 22 acquiring additional vulnerabilities is increased. For example, upon transporting the remediated computer system 26c to a remote location, a user of the remediated computer system 26c may utilize a local Internet service provider (ISP) to couple the remediated computer system 26c to the Internet. Such usages would dramatically increase the possibility that the remediated computer system 26c may acquire new vulnerabilities not present when disconnection from the remediated computer network 19 occurred.

The disconnections of the remediated computer network 26c hereinabove described are “cold” disconnections taking place as part of a controlled powering down of the remediated computer system 26c. Uncontrolled disconnections, for example, a power failure, or “hot” disconnections, for example, by physically disconnecting a powered up portable computer from a powered-up docking station, may pose additional complications. For example, the network protection initialization process 110 may not be able to execute before the remediated computer network 26c is disconnected from the remediated network 19. As will be more fully described below with respect to FIG. 5, if the network initialization process 110 is unable to execute prior to disconnection of the remediated computer system 26c and the remediated computer system 26c was not previously initialized, the network protection process 130 will deny re-entry of the remediated computer system 26c into the remediated computer network 19.

Referring next to FIG. 6, the network protection process 130 will now be described in greater detail. It should be clearly understood, however, that while it is preferable that the disconnected computer system 26c is initialized in accordance with the initialization process 110 set forth in FIG. 5, it is fully contemplated that the network protection process 130 described herein may be used to protect a computer network from disconnected computer systems which have not been initialized in the described manner. For example, by hard coding a disconnected computer system with the ability to recognize the presence of a client remediation server on a computer network, it will be possible for any disconnected computer system, upon attempting to enter a computer network, to recognize that the computer network is a remediated computer network and to initiate the process 130 so that the remediated computer network is protected from vulnerabilities residing within the disconnected computer system until such time that the disconnected computer system may attend to the remediation of such vulnerabilities.

Thus, the protection process 130 begins at step 132 and, at step 134, entry (if the disconnected computer system 26c had never been connected to the remediated computer network 19) or re-entry (if the disconnected computer system 26c had previously been connected to the remediated computer network 19) of the disconnected computer system 26c (which, as previously set forth may be an initialized disconnected computer system or an uninitialized disconnected computer system equipped to recognize client remediation servers) into the remediated computer network 19 commences. As will be more fully described below, the disconnected computer system 26a is equipped to selectively quarantine itself from the remediated computer network 19 with which the disconnected computer system 26a seeks re-entry. Accordingly, upon initiation of re-entry of the disconnected computer system 26a at step 134, for example, by the disconnected computer system 26c generating a data packet which would begin the process of registering the disconnected computer system 26c with the remediated computer network 19, the process proceeds to step 136 where the disconnected computer system 26c is, in effect, isolated from the remediated computer network 19 from the disconnected computer system 26c until the disconnected computer system 26c is remediated. In this manner, any vulnerabilities residing on the disconnected computer system 26c are resolved before it is allowed to re-enter the remediated computer network 19. To remediate a disconnected computer system, the client remediation server 22 is first checked to see there are any pending resolutions for the disconnected computer system 26c, typically, remediations that were scheduled for execution but failed because the disconnected computer system 26c was already disconnected from the remediated computer network 19 at the time at which the remediation was scheduled. Any pending remediations are then executed, thereby resolving any vulnerabilities residing on the disconnected computer system 26c.

The disconnected computer system 26c isolates itself from the remediated computer network 19 at step 136 by closing a firewall residing on the disconnected computer system 26c. As is well known in the art, a firewall sits at a junction point between two devices and operates by limiting the traffic which may be exchanged between the devices on respective sides of the junction point. Broadly speaking, a firewall may be implemented in hardware or software and may be classified in one of four broad categories-packet filters, circuit level gateways, application level gateways and stateful multilayer inspection firewalls. Here, however, it is contemplated that the firewall used to isolate the disconnected computer system 26c from the remediated computer network 19 is a packet filter implemented in software.

While it was previously stated that the firewall serves to “isolate” or “quarantine” the disconnected computer system 26c from the remediated computer network 19, it should be clearly understood that the firewall is structured to allow specified data packets to travel between the disconnected computer system 26c and the remediated computer network 19 while rejecting all other data packets. More specifically, the firewall is switchable between a first (or “closed”) state and a second (or “open”) state. In the closed state, the firewall will reject all inbound and outbound transmission control protocol/user datagram protocol (TCP/UDP) data packets except data packets originating at or destined for the client remediation server 22 and data packets needed for the disconnected computer system 26b and remediated computer network 19 to confirm that the disconnected computer system 26b is attempting to re-enter its home network, NT LAN manager (NTLM), NTLMv2 and Kerberos packets. The firewall may also be set to reject outbound traffic from sources other than identified processes related to the remediation agent. In general, the firewall may be used to filter for or against certain destinations, to filter for or against certain types of packets, to filter for or against certain sources, and even to filter for or against specific elements contained within the packets. These tools are applied alone or in combination to effectively quarantine the disconnected computer system except for the base level of traffic needed to get into the network to obtain and execute the remediations. Conversely, in the open state, the firewall will not restrict inbound or outbound traffic.

Upon closing the firewall at step 136, the process continues on to step 138 where the disconnected computer system 26c determines, based upon certain data packets exchanged with the network with which it is seeking to enter, whether the disconnected computer system is attempting to re-enter its home network. More specifically, in one example, the disconnected computer system 26c will attempt to transmit its unique identifier to the client remediation server 22. The disconnected computer system 26c will then look for the unique identifier of the client remediation server 22 in response. Upon receipt of the unique identifier of the client remediation server 22, the disconnected computer system 26c will compare the received identifier to that previously stored in the memory subsystem 162 during execution of the network protection initialization process 110.

If, at step 138, the received identifier fails to match the unique identifier for the client remediation server 22 stored in the memory subsystem 162, the disconnected computer system 26c will conclude that it is attempting to re-enter an unremediated network. The process 130 will then continue on to step 140 for a determination as to whether the disconnected computer system is permitted to enter an unremediated network outside of its home network. Generally, permission to enter an unremediated network is granted by the network administrator, typically, when installing disconnected machine rules 176 in the memory subsystem 162. If a review of the disconnected machine rules 176 at step 140 indicates that the disconnected computer system 26c is not permitted to enter unremediated networks, the process 130 will continue on to step 142 where the attempt to enter the computer network 19 is terminated. The process 130 will then end at step 144. Conversely, if it is determined at step 140 that the disconnected computer system 26c is permitted to enter an unremediated computer network, the process 130 will continue on to step 146 where the user of the disconnected computer system 26c will be advised of the prospective entry into an unremediated computer network. The user of the disconnected computer system 26 will then decide whether to enter the unremediated network and the process 130 will end at step 146.

Returning now to step 138, if it is determined the received identifier matches the unique identifier for the client remediation server 22 stored in the memory subsystem 162, the disconnected computer system 26c will conclude that it is attempting to re-enter the remediated computer network 19. The process 130 will then continue to step 148 where the client remediation server 22 will determine that if there any pending remediations for the disconnected computer. Typically, the pending remediations for a disconnected computer system will be those remediations which were previously scheduled for the computer system 26c but could not be executed because, at the scheduled time of execution, the computer system 26c had been disconnected from the remediated computer network 19. Typically, the client remediation server 22 would maintain a list of pending remediations in the remediation profiles portion 188 of the memory subsystem 182. If there are pending remediations contained in the remediation profiles portion 188 of the memory subsystem 182, the process 130 continues on to step 152 where the client remediation server performs each of the pending remediations in the manner previously described. In this manner, vulnerabilities of the disconnected computer system 26c are resolved.

By resolving the vulnerabilities of the disconnected computer system 26c at step 150 or upon determining, at step 148, that there are no pending remediations for the disconnected computer system 26c, the risk to the remediated computer network 19 is exposed as a result of the re-entry of the disconnected computer system 26c into the remediated computer network 18 has been minimized. The process 130 may now proceed to step 152 where the disconnected computer system 26c can re-enter the remediated computer network 19. To do so, the disconnected computer system 26c lowers the firewall separating the disconnected computer system 26c from the remediated computer network 19. The disconnected computer system 26c having re-entered the remediated computer network 19 at step 152, the process 130 will end at step 130.

As previously set forth, a computer system is considered to be disconnected from a computer network when it is: (a) powered down; or (b) physically disconnected from the computer network. It should be appreciated that the risks facing the disconnected computer system will vary depending on the type of disconnection that has occurred. When disconnected as a result of the powering down of the computer system, the risk facing the computer system is that it will miss a scheduled remediation and, as a result, a vulnerability which would have otherwise been remediated will remain. Conversely, when disconnected as a result of a physical disconnection of the computer network, the computer system faces additional risks as well, the greatest of which will be the exposure of the disconnected computer system to new vulnerabilities, often as a result of the introduction of new hardware, software or data thereto. Thus, while executing a set of pending remediations may be a suitable resolution when a computer system is disconnected as a result of a powering down thereof, such a solution may be deficient if the disconnection occurred as a result of a physical disconnection of the computer system from the remediated computer network. Accordingly, in one embodiment of the invention, it is contemplated that, if disconnection of the computer systems 26c resulted from a physical disconnection, not only will the client remediation server 22 have to execute all pending remediations set forth in the remediation profile for the disconnected computer system, the client remediation server 22 will also have to execute a set of supplementary remediations. For example, the client remediation server 22 may have to scan the disconnected computer system 26c for nefarious software, for example, computer viruses. Further, by way of example, the client remediation server 22 may be required to generate an entirely new remediation profile for the disconnected computer system 26c. In some instances, for simplicity, this type of process could be performed on all disconnected computers.

Rather than having to determine if there are any pending remediations for the disconnected computer system 26c which must be executed before the disconnected computer system 26c can be permitted to enter the remediated computer network 19, in still another embodiment of the invention, it is contemplated that the client remediation server 22 may remediate the disconnected computer system 26c by simply performing a scan for viruses, worms and the like on the disconnected computer system 26c. In this embodiment, the disconnected computer system 26c would again isolate itself from the remediated computer network 19, again by raising its firewall. The firewall would remain in place while the client remediation server 22 performs a scan for viruses, worms and the like for the disconnected computer system 26. Upon completion of the scan and removal of any viruses, worms or the like detected thereby, the disconnected computer system 26c would be deemed as having been remediated. The disconnected computer system 26c would then lower its firewall, thereby completing entry of the disconnected computer system 26c into the remediated network 19.

Heretofore, applications of the remediation agent 163 and the remediation application 184 for the resolution of vulnerabilities in the computer systems 26a, 26b, 26c of the remediated computer network 19 have been set forth in detail. It should be clearly understood, however, that the remediation agent 163 and the remediation application 184 may also be used for risk mitigation. For example, as part of the foregoing processes, a vulnerability in the disconnected computer system 26c may be identified and mapped to a remediation signature. Rather than instructing the remediation agent 163 to resolve the vulnerability, however, the remediation agent 163 may instead be instructed to mitigate the risk posed to the remediated computer network 19. For example, the virus or worm which forms the basis for the vulnerability may be structured to attack a specific port of the disconnected computer 26c. Rather than resolving the vulnerability by removing the virus or worm, the remediation agent 163 may instead be instructed to use the firewall to close off the port under attack, to filter for specific identified elements, to filter for actions from specific identified processes, or otherwise be employed to temporarily or permanently block key access or filter key areas to mitigate the identified risk until a more elegant solution may be obtained. By doing so, the risk to the remediated computer network 19 may be quickly mitigated. Such an approach may be desirable in various situations, for example, if the proposed remediation is deemed to be particularly time consuming or risky. In this manner, the same firewall used for more broadly closing access to (or quarantining) the client computer on start-up until pending and/or start-up remediations have been obtained and executed, may be leveraged in a more targeted manner to act as a component in the execution of some remediation signatures.

While the present invention has been illustrated and described in terms of particular apparatus and methods of use, it is apparent that equivalent parts may be substituted for those shown and other changes can be made within the scope of the present invention as defined by the appended claims. For example, in alternate embodiments thereof, it is contemplated that the present invention may be practiced without employing a central remediation server 12 and migrating the functionality disclosed herein as residing on the central remediation server 12 to the client remediation server 22. In other alternate embodiments, the client remediation server 22 could take on the role and functionality of the remediation agents 163 distributing the execution from the server instead of local execution on the client computer. In yet other alternative embodiments, as understood by those of skill in the art, the functions between these three architecture levels may be selectively combined or migrated between components, between servers, or the components themselves combined or migrated while still providing many of the benefits of the claimed invention.

The particular embodiments disclosed herein are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A method for protecting a computer network from vulnerabilities, comprising:
quarantining a computer system seeking to connect to said computer network until said quarantined computer system is remediated; and
upon completing remediation of said quarantined computer system, connecting said remediated computer system to said computer network.

2. The method of claim 1, wherein said quarantine of said computer system is self-initiated.

3. The method of claim 2, wherein said remediation of said computer system is performed by said computer network.

4. The method of claim 1, wherein said quarantining of said computer system seeking to connect to said computer network further comprises:
said computer system raising a firewall for blocking traffic between said computer system and said computer network.

5. The method of claim 4, wherein said firewall permits a flow of vulnerability resolution information therethrough.

6. The method of claim 5, and further comprising lowering said firewall after said computer system has been remediated using said vulnerability resolution information.

7. For a computer network comprised of a plurality of computer systems and a client remediation server coupled to each one of said plurality of computer systems, said client remediation server remediating said computer network by resolving vulnerabilities in said plurality of computer systems, a method for protecting said remediated computer network from unresolved vulnerabilities, comprising:
if one of said computer systems of said remediated computer network is disconnected from said remediated computer network, upon a subsequent re-connection of said computer system to said remediated computer network, temporarily limiting exchanges between said remediated computer network and said computer systems.

8. The method of claim 7, wherein exchanges between said computer system and said remediated computer network are limited until said computer system has been checked, by said client remediation server, for pending remediations.

9. The method of claim 8, wherein limiting exchanges between said computer system and said remediated computer network further comprises said computer system raising a firewall upon reconnecting to said remediated computer network.

10. The method of claim 9, wherein said computer system raising a firewall upon reconnecting to said remediated computer network further comprises filtering out non-remediation-related traffic between said computer system and said remediated computer network.

11. The method of claim 10, and further comprising removing said limitations on exchanges between said computer system and said remediated computer network upon said client remediation server executing said pending remediations for said computer system.

12. The method of claim 11, wherein removing said limitations on exchanges between said computer system and said remediated computer network further comprises said computer system lowering said firewall.

13. The method of claim 12, wherein removing said limitations on exchanges between said computer system and said remediated computer network further comprises permitting non-remediation-related traffic to pass between said computer system and said remediated computer network without filtering.

14. A method for protecting a computer network from nefarious software associated with a computer system being connected to said computer network, comprising:
upon initiating a connection between said computer system and said computer network, quarantining said computer system from said computer network;
performing a scan on said computer system;
lifting said quarantine of said computer system upon completing the removal of any nefarious software detected by said scan.

15. The method of claim 14, wherein said computer system is quarantined from said computer network by a firewall residing on said computer system.

16. The method of claim 15, wherein said nefarious software detection and removal is performed by said computer network.

17. The method of claim 15, wherein said nefarious software detection and removal is performed by said computer system.

18. The method of claim 15, wherein said firewall permits traffic between said computer system and said computer network if said traffic is related to said nefarious software detection and removal.

19. The method of claim 18, wherein said nefarious software is a computer virus.

20. The method of claim 18, wherein said nefarious software is a worm.

21. A remediated computer network comprising:
a computer system; and
a client remediation server coupled to said computer system, said client remediation server configured to periodically resolve vulnerabilities in said computer system;
wherein said computer system includes a firewall for periodically isolating said computer system, from said remediated computer network, until said client remediation server resolves vulnerabilities of said computer system.

22. The apparatus of claim 21, wherein said computer system is configured to raise said firewall to isolate said computer system from said remediated computer network whenever said computer system disconnects from and subsequently reconnects to said computer network.

23. The apparatus of claim 22, wherein said computer system is configured to raise said firewall upon each power-up thereof.

24. The apparatus of claim 22, wherein said remediated computer network is a local area network (LAN) and said computer system is configured to raise said firewall upon initiating registration with said LAN.

25. The apparatus of claim 22, wherein said remediated computer network is a wide area network (WAN) and said computer system is configured to raise said firewall upon initiating registration with said WAN.

26. The apparatus of claim 22, wherein said remediated computer network is a wireless local area network (WLAN) and said computer system is configured to raise said firewall upon initiating registration with said WLAN.

27. The apparatus of claim 22, wherein said remediated computer network is a virtual private network (VPN) and said computer system is configured to raise said firewall upon initiating registration with said VPN.

28. The apparatus of claim 22, wherein said remediated computer network is a wireless virtual private network (WVPN) and said computer system is configured to raise said firewall upon initiating registration with said WVPN.

29. The apparatus of claim 22, wherein said remediated computer network is the Internet and said computer system is configured to raise said firewall upon initiating registration with the Internet.

30. A computer system, comprising:
a processor subsystem;
a memory subsystem coupled to said processor subsystem;
at least one application residing in said memory subsystem and executable by said processor subsystem; and
a firewall switchable between a closed position in which traffic to and/or from said computer system is restricted and an open position in which traffic to and/or from said computer system is unrestricted;
wherein said firewall is configured to switch into said closed position upon power-up of said computer system and upon initiation of registration with a computer network.

31. The computer system of claim 30, wherein said firewall is configured to pass, in said closed position, first and second types of traffic, said first type of traffic being related to registration of said computer system with said computer network and said second type of traffic being related to remediation of said computer system by a client remediation server coupled to said computer network.
